(19) United States
(12) Patent Application Publication
(10) Pub. No.: US 2003/0147502 A1
(43) Pub. Date: Aug. 7, 2003

(54) X-ray imaging apparatus with tube side filter for dividing the x-ray beam into multiple beams of differing intensities

(76) Inventors: Bjorn Heismann, Erlangen (DE); Thomas Von Der Haar, Nuernberg (DE)

Correspondence Address: SCHIFF HARDIN & WAITE, 6600 SEARS TOWER, 233 S WACKER DR, CHICAGO, IL, 60606-6473, US

(21) Appl. No.: 10/316,752

(22) Filed: Dec. 11, 2002

(30) Foreign Application Priority Data
Dec. 11, 2001 (DE) 10160613.3

(51) Int. Cl. G21K 3/00

(52) U.S. Cl. 378/156

(57) ABSTRACT

An X-ray imaging apparatus for determining image data about the distribution of physical and chemical constituents in examination subjects of a human or animal nature or in materials or security inspection, a tube-side modification of a conventional CT apparatus to allow a two-spectra method to be employed but without an increase in the radiation stress on the subject. A two-part filter is introduced between the X-ray source and the subject to produce X-rays of at least two different intensities for transirradiating the subject.

### BACKGROUND OF THE INVENTION

1. Field of the Invention

The present invention is directed to an X-ray apparatus of the type suitable for determining image data representing the distribution of physical and chemical constituents in human or animal examination subjects as well as in inanimate materials, or for security inspection.

2. Description of the Prior Art

The result of all radiographic methods such as, for example, computed tomography, mammography, angiography, X-ray inspection technology and comparable methods is the presentation of the attenuation of an X-ray beam along its path from the X-ray source to the X-ray detector. This attenuation is caused by the transirradiated media or materials along the beam path. The attenuation is usually defined as the logarithm of the intensity of the attenuated to the primary radiation and, when referenced to a path normal, is referred to as the attenuation coefficient of the material.

Instead of the attenuation coefficient, many radiographic examination devices employ a value—the CT number—normalized to the attenuation coefficient of water for the presentation of the attenuation distribution of an X-ray beam in an examination subject. This is calculated from a current attenuation coefficient μ determined by measurement and the reference attenuation coefficient, determined according to the following equation:

$$C = 1000 \times \frac{μ - {μ}_{{H}_{2} O}}{{μ}_{{H}_{2} O}} [ HU ] \qquad ( 1 )$$

with the CT number C in Hounsfield [HU] units. A value C_{H2}O=0 HU derives for water and a value C_{AIR}=−1000 HU derives for air.

Since the two presentations can be transformed into one another, or are equivalent, the general term “attenuation” refers to the attenuation coefficient μ as well as to the CT value. As used herein, further, the terms “material” and “tissue” are interchangeably employed. It makes no difference that a material in the context of a medical examination can be anatomical tissue and, conversely, to use tissue as meaning an arbitrary material of an examination subject in materials and security inspection.

Increased attenuation values can be attributed either to materials with a higher atomic number such as, for example, calcium in the skeleton or iodine in a contrast agent or to an increased soft part density such as in the case of a pulmonary node. The local attenuation coefficient μ at the location is dependent on the X-ray energy E radiated into the tissue or material and on the local tissue or material density p in conformity with the following equation:

$$μ = μ ( E , {r}^{->} ) = ( \frac{μ}{ρ} ) ( E ) \times ρ ( {r}^{->} ) \qquad ( 2 )$$

with the energy-dependent and material-dependent mass attenuation coefficient

$$( \frac{μ}{ρ} ) ( E ) .$$

The energy-dependent X-ray absorption of a material, as defined by its effective atomic number, therefore is superimposed on the X-ray absorption influenced by the material density. Materials or tissue with different chemical as well as physical composition therefore can exhibit identical attenuation values in the X-ray image. Conversely, conclusions about the material composition of an examination subject cannot be drawn from the attenuation value of an X-ray exposure.

A correct interpretation of this unclear distribution of the attenuation values in an X-ray image produced with a radiographic examination method usually can ensue only on the basis of morphological criteria in the medical sector and usually requires a radiologist with decades of experience in his/her field. In some instances, structures that are noticeable with increased attenuation values in the image cannot be classified. For example, a hilus-proximate sclerosis (calcification) on a thorax overview is difficult to distinguish from a vessel lying orthographically relative to the image plane. A diffuse calcium deposit, for example, can be difficult to distinguish from a fresh lesion.

In materials and security inspection as well, the inspector generally supplements the presentation of an attenuation value distribution with his/her personal expertise and professional experience. Nonetheless, a reliable discrimination of a explosives mixture exhibiting plastic-bond from a non-explosive plastic, for example, is not directly possible from an X-ray image.

Methods for the presentation of characteristic values of materials are required for this purpose. In “Materialselektive Bildgebung und Dichtemessung mit der Zwei-Spektren-Moethode, I. Grundalgen und Methodik”, W. Kalender, W. Bautz, D. Felsenberg, C. Süβ and E. Klotz, Digit. Bilddiagn. 7, 1987, 66-77, Georg Thieme Verlag, W. Kalender et al. describe a method for basic material resolution in X-ray exposures. The method is based on the effect that materials and tissue with a higher atomic number absorb low-energy X-rays to a clearly greater extent that materials or, respectively, tissue with a higher atomic number. Given higher X-ray energies, in contrast, the attenuation values approach one another and are mainly a function of the material density.

This effect can be attributed essentially to two physically distinguishable phenomena: The first is absorption of the X-rays, which is dependent on the energy and on the atomic number of the transirradiated medium (photo-effect), and second is incoherent scatter, which is essentially dependent on the electron density and, thus, on the physical density of the transirradiated medium (Compton effect).

As used herein, the term “atomic number”—insofar as not indicated otherwise—is not employed in the strict element-related sense but refers instead to an effective atomic number of tissue or material that is calculated from the chemical atomic numbers and atomic weights of the constituents elements of the tissue or material.

In the method proposed by W. Kalender et al., the X-ray attenuation values of an examination subject are measured with X-rays having lower energy and higher energy, and the respective values that are obtained are compared to the corresponding reference values of two basis materials such as, for example, calcium (for skeletal material) and water (for soft tissue). It is assumed that every measured value can be presented as a linear superposition of the measured values of the two basic materials. For example, a skeletal part and a soft tissue part can be calculated for each element of the graphic presentation of the examination subject from the comparison to the values of the basic materials, so that a transformation of the original exposures into presentations of the two basic materials, skeletal material and soft part tissue, results.

The basic material resolution or two-spectra method is thus suited for separating or distinguishing anatomical structures in human and animal tissues with highly different atomic number. In materials and security inspection, for example, a separation can ensue according to pre-defined types of materials, are referred to as material classes. A functional presentation that allows recognition of physical and chemical characteristics of the examined materials, or variations of these characteristics, within a type of material is not the objective of basic material resolution.

Lower-energy and higher-energy X-rays must be generated quasi simultaneously for the purpose of the two-spectra method—particularly in computed tomography and in functional imaging of a living subject exhibiting movement (for example, due to respiration or heart motion), so as to preclude disturbances due to this patient movement. Two conventional methods are usually utilized for this purpose:

1. The tube high-voltage is pulsed, i.e. the kV values are switched between two different values in the millisecond range from pulse to pulse dependent on the exposure mode.

2. Adaptation of the X-ray apparatus at the detector-side. Since an X-ray tube does not emit mono-energy radiation but a relatively broad spectrum of X-rays, a number of exposures with different X-ray spectra can be obtained in one measurement event by using an energy-sensitive detector. This supplies separate measured signals for spectral ranges that generally lie next to one another. Attenuation values thus are simultaneously obtained for different spectral ranges of the X-ray spectrum that are separated from one another, i.e. a number of X-ray images at different beam energies in one exposure cycle. This number is dependent on the embodiment and wiring connections of the detector. Such detectors can be realized as layer structure detectors, utilizing the effect that the penetration depth of X-rays into the layer system of the detector is determined by the energy of the X-ray quanta. As an alternative to layer detectors, quantum detectors can be employed as energy-sensitive detectors.

Both methods are extremely complicated, particularly the second method, which cannot be integrated into systems wherein the X-ray source and detector rotate around the examination subject. This second method is mainly suited for flat image detectors that are used with a stationary tube.

### SUMMARY OF THE INVENTION

An object of the present invention is to provide an apparatus for implementing the two-spectra method which avoids increasing the radiation stress on the examination subject.

This object is achieved in an X-ray apparatus for determining the distributions of density and atomic number in an examination subject, having an X-ray source for emitting X-rays, an X-ray detector for detecting the X-rays emitted by the X-ray source and for converting the X-rays into electrical signals for further processing, a signal processing device for processing the electrical signals of the X-ray detector, and an at least two-part filter that divides the beam into at least two beams that differ in intensity, that is introduced into the beam path between the X-ray source and the examination subject.

In an embodiment of the invention, the beam path between the X-ray source and the examination subject is fan-shaped.

It is advantageous in this arrangement to arrange the two-part filter such that it divides the fan-shaped beam into two halves.

It can also be advantageous to arrange the two-part filter such that it divides the fan-shaped beam into two symmetrical halves that differ, however, in intensity or their spectral composition.

The (at least) two parts of the filter can differ by virtue of being respectively composed of different materials.

Alternatively, the two parts of the filter can differ by virtue of different thicknesses of the same or different materials.

Metals such as aluminum, copper, titanium, tungsten, etc. are advantageous as filter material.

Advantageously, the examination subject is exposed to the ray fan produced by a first part of the filter for the registration of a first distribution of an X-ray absorption of the examination subject, and the examination subject is exposed to the beam produced by a second part of the filter for the registration of a second distribution of an X-ray absorption of the examination subject.

The term “X-ray spectrum” is used herein with a broader meaning than the mere spectral distribution (the spectrum) of an X-rays emitted by the X-ray source of the apparatus, which is characterized by an intrinsic intensity. At the X-ray detector, different spectral parts of the radiation are converted with different efficiencies and are thus differently weighted. The effective spectral distribution resulting therefrom with its intrinsic intensity is referred to as an X-ray spectrum herein.

The present invention enables the calculation of the spatial distribution of the average density and of the effective atomic number from an interpretation of the spectrally influenced measured data of an X-ray apparatus. New types of contrast, particularly with respect to the chemical and physical composition of the examination subject, are obtained in this manner. This functional presentation of an examination subject that was heretofore reserved for magnetic resonance systems opens many new applications for X-ray diagnostics as well as X-ray inspection technology.

For example, the presentation of the distribution of the atomic number allows perceptions about the biochemical composition of an examination subject, contrasts on the basis of the chemical composition in organs that were previously presented with homogeneous density, a quantitative determination of body constituents such as, for example, iodine or the like, and allows calcifications to be segmented based on the atomic number. The isolated density presentation of a subject allows a precise determination of the center of gravity and a density mapping of subjects as is undertaken, for example, in osteoporosis, among other things.

In the field of security technology, the inventive method achieves a more dependable detectability of dangerous components, particularly explosive substances. In materials testing, access to the quantitative examination of the material composition and the density distribution in the test subjects become available.

### DESCRIPTION OF THE DRAWINGS

FIG. 1 is a schematic view of an inventive CT apparatus.

FIGS. 2A and 2B schematically illustrate the functioning of an inventive two-spectra filter.

FIG. 3 shows the occurrence of identical attenuation values μ for materials with different composition on the basis of an iso-absorption line.

FIG. 4 shows the energy dependency of the X-ray attenuation for three elements.

FIG. 5 shows two iso-absorption lines of a tissue type for two different X-ray spectra.

### DESCRIPTION OF THE PREFERRED EMBODIMENTS

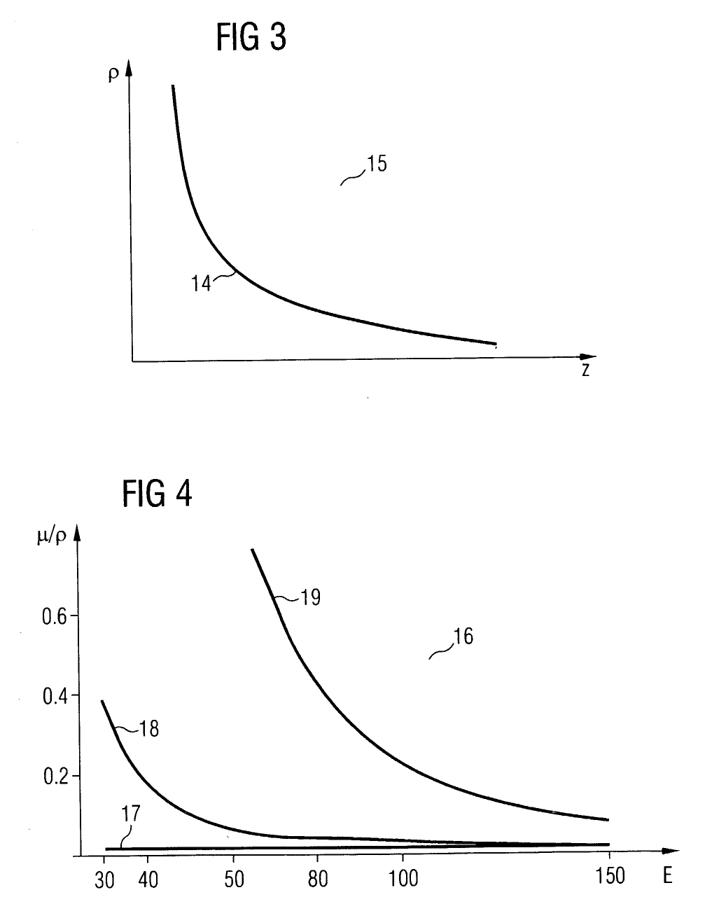

The iso-absorption line 14 of the diagram 15 of FIG. 3 connects all values pairs (ρ, Z) having an identical attenuation value μ or, respectively, C given a defined X-ray spectrum. The presentation of FIG. 3 illustrates that information about the nature and composition of a tissue or material cannot be derived solely from the attenuation values of an X-ray image. For identifying tissue types in the X-ray image, a radiologist usually relies on his/her knowledge of anatomy and seeks irregularities on this basis. In order to clarify the identity of the irregularities, a medical practitioner then in turn is forced to have recourse to empirical values and morphological criteria. Similarly, a person skilled in the art of materials and security inspection makes use of his/her background of professional experience for interpreting the radiographic finding.

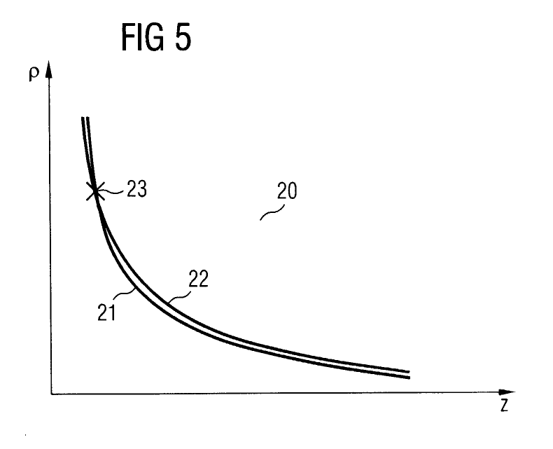

X-rays are attenuated to different degrees by different materials and dependent on the energy of the X-rays. FIG. 4 illustrates this on the basis of the energy dependency 20 of the mass attenuation coefficient for water 17, calcium 18 and iodine 19. This can be attributed to differently acting attenuation mechanisms in the different materials. In the diagnostically relevant energy range of the X-rays, the X-ray attenuation is attributed essentially to the absorption caused by the photo-effect and the scatter based on the Compton effect. The absorption is particularly relevant for lower energy X-rays and for tissues with a higher atomic number. The scatter exhibits a slight dependency on the energy of the X-rays and is essentially dependent on the electron density mediated via the physical density of the tissue.

The effective atomic number Z of a specific tissue type (which as noted above is called atomic number herein for simplification) is calculated from the actual atomic numbers Zᵢ of the constituent elements, their atomic weights Aᵢ and their local, material-equivalent densities ρᵢ, for example as:

$$Z = {\{ \frac{{\sum }_{i} \frac{{ρ}_{i}}{{A}_{i}} {ρ}_{i} {Z}_{i}^{4}}{{\sum }_{i} \frac{{ρ}_{i}}{{A}_{i}} {ρ}_{i}} \}}^{\frac{1}{3}} \qquad ( 3 )$$

For pure calcium, Z_{Ca}=20, approximately Z_{CaH2}≅16.04 for calcium hydride and approximately Z_{H2O}≅7.428 for water. The chemical or biochemical composition of a subject can therefore be acquired very well via the atomic number Z.

A pre-condition for a calculation of the atomic number distribution and density distribution in an examination region is at least two X-ray exposures of the region that are identical in exposure geometry but which were produced with different energies of the applied X-rays. The Z-resolution and the ρ-resolution can be improved with the employment of more than two X-ray exposures made with different X-ray energy, but the radiation load is increased as a result. This possibility therefore is not always recommended when examining a patient.

The point of departure for the conversion of image data based on attenuation value into distribution images of the atomic numbers and of the material or tissue density is the knowledge of the iso-absorption lines for each X-ray spectrum of an X-ray apparatus, defined by the tube-side X-ray emission spectrum S(E) as well as the detector-side detector apparatus function w(E). The latter supplies a mathematical description of the detector type.

As already mentioned, as used herein X-ray spectrum is not the narrow term of spectral distribution of an X-ray emitted by the X-ray source of the apparatus, but is a broader term that takes into consideration the different weighting of different spectral regions of the emission spectrum of the X-ray tube at the side of the X-ray detectors. A measured attenuation value therefore derives from the direct attenuation of the radiation spectrum emitted by the X-ray tube and from the spectral efficiency of the X-ray detector that is employed. Both values are system-specific quantities and must be determined either directly or indirectly with the attenuation values of calibration specimens. They are the basis for calculating the iso-absorption lines.

Fundamentally, as many iso-absorption lines as the number of attenuation values required for covering the span of X-ray attenuations in the X-ray exposures must be determined. An iso-absorption line need not be calculated for every theoretically occurring attenuation value; as needed, iso-absorption lines that have not been calculated can be made available by interpolation or other suitable averaging methods.

There are various methods for determining the iso-absorption lines in the form of curve families Cᵢ (ρ, Z) or μᵢ (ρ, Z). For example, they can be calculated on the basis of a physical model that simulates the X-ray attenuations Cᵢ or μᵢ for materials with different atomic numbers and with different material densities for each relevant combination of S(E) and w(E). A experimental determination with calibration materials is likewise possible.

With the determination of the iso-absorption lines for the required X-ray attenuation values and combinations of S(E) and w(E), the pre-conditions have been created for a transformation of image data that represent the attenuation values of X-rays that have passed through a tissue into image data that represent a distribution of the atomic number, or of the material density, in the corresponding tissue.

The transformation is based on the curve families of iso-absorption lines that were previously determined and are kept available as a dataset.

A transformation ensues by picture elements. The following is based on a transformation of an X-ray attenuation value distribution based on two X-ray images registered with identical exposure geometry but two different X-ray emission spectra in view of their energy. This is the minimum pre-condition for an implementation of an inventive transformation. More than two X-ray exposures can be employed, however, given more than two different energy distributions of the X-rays, generated, for example, by a multi-part filter, as explained below.

In order to transform a selected picture element, the attenuation values C₁, or μ₁ for this picture element are determined from the first X-ray image (registered with the X-ray spectrum S₁ (E) and the detector apparatus function w₁ (E) and the attenuation values C₂ or μ2 are determined from the second X-ray image registered with S₂ (E) and w₂ (E) (given more than two spectra, these are the respectively corresponding S(E) values and w(E) values). The values S₁ (E), S₂ (E), w₁ (E) and w₂ (E) form the parameters for a subsequent selection of the iso-absorption lines to be allocated to the respective attenuation values. As already mentioned, each X-ray spectrum S(E) is characterized by its specific intensity.

The first iso-absorption line that is determined is a curve that satisfies the conditions C₁ or μ₁ given the parameters S₁ (E) and w₁ (E), and the second iso-absorption line that is determined is a curve that satisfies the conditions C₂ or μ₂ given the parameters S₂ (E) and w₂ (E). Examples of a first iso-absorption line 21 and a second iso-absorption line 22 obtained in this way are shown in the diagram 20 of FIG. 5.

In the transformation method, the intersection 23 is calculated as a meet of the two curves 21 and 22. For example, the curve section 23 can be determined by means of a local linear transformation or by means of iterative intersection locating. Since the two curves 21 and 22 represent two different attenuation values for the same picture element and therefore represent an identical sub-region of tissue under examination, both attenuation values must have been caused by the same type of material or tissue. The coordinates (ρ, Z) of the curve intersection therefore reproduce the material density and the atomic number of the tissue sub-region to be allocated to the picture element.

The atomic number value Z determined in this way is entered into the atomic number distribution as a corresponding picture element value, and the identified material density value p is analogously entered into the density distribution. This is implemented for all picture elements of an X-ray image.

For X-ray spectra with relatively low energy, the X-ray attenuation by the photo-effect dominates; for X-ray spectra with relatively high energy, the X-ray attenuation by the Compton effect dominates. Expressed more precisely, the influence of the atomic number on the X-ray attenuation values of an exposure is relatively greater for lower X-ray energy than for higher X-ray energy. The influence of material or tissue density on the X-ray attenuation values behaves exactly inversely. Advantageously, a first X-ray spectrum therefore is selected first such that a clear part of the first X-ray attenuation values is derived from the influence of the atomic numbers of the tissue or material under examination, and a second X-ray spectrum is then selected such that the densities of the examination subject have a clear influence on the second X-ray attenuation values.

For computed tomography (CT), the energies of the X-ray spectra therefore are selected such that an adequate energy spacing exists between a first X-ray spectrum and a second X-ray spectrum without having to increase the X-ray dose into ranges that are harmful to patients.

This is inventively realized by a filter with two or more parts that is introduced into the beam path between the patient and the X-ray tube and thus hardens the X-ray tube spectrum with respect to its energy in the line direction of the CT system.

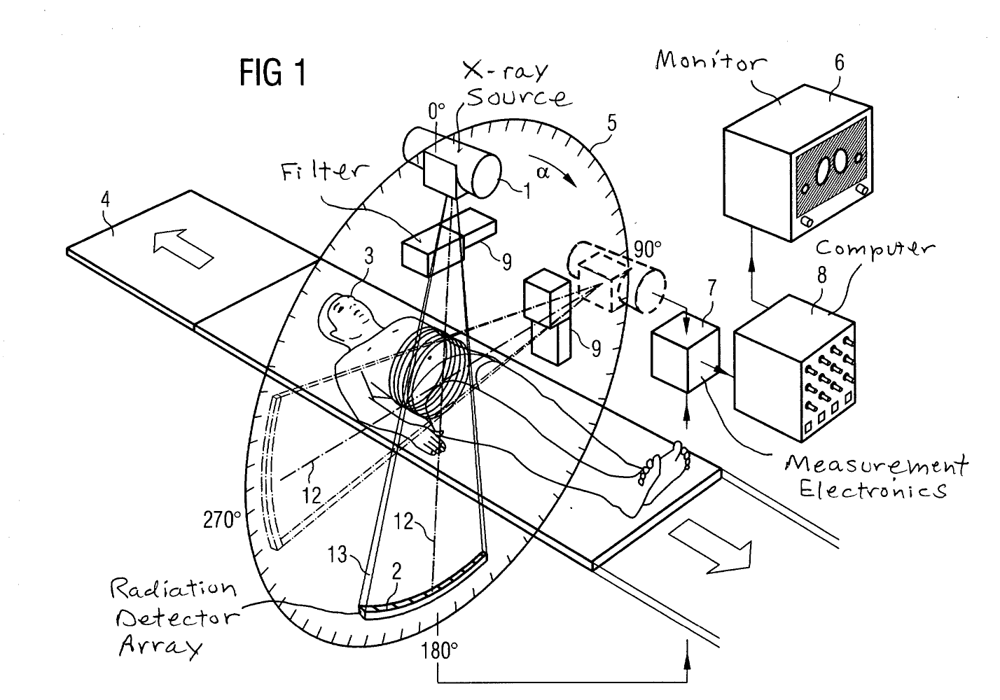

FIG. 1 schematically shows a CT apparatus into which a two-part filter 9 is inventively introduced between the examination subject 3 and X-ray tube 1. In this apparatus, the X-ray tube 1 and the radiation receiver 2 (detectors) rotate in common around a rotational center that is also the center of the circular measurement field 5 and in which the patient 3 under examination is located on a patient bed 4. The patient bed can be displaced along the longitudinal body axis in order to be able to examine different parallel planes of the patient 3. As can be seen from the drawing, CT exposures yield transverse tomograms, i.e. images of body slices that are oriented essentially perpendicularly to the body axis. This slice presentation method represents the distribution of the attenuation value μ_{z} (x, y) (z is the position on the longitudinal body axis). Computed tomography (CT) requires projections from many different angles α. For producing a tomogram, the beam cone emitted by the X-ray tube 1 is gated such that a planar ray fan arises that defines one-dimensional central projections of the transirradiated slice. For exact reconstruction of the distribution of the attenuation values μ_{z} (x, y), this ray fan must reside perpendicularly on the rotational axis and must also be spread to such an extent that is completely covers the targeted slice of the examination subject from every projection direction α. The ray fan penetrating the subject is intercepted by detectors that are linearly arranged on a circular segment. There are up to 1000 detectors in commercially available devices. Each individual detector reacts to the incident rays by producing electrical signals whose amplitude is proportional to the intensity of these rays.

Each individual detector signal belonging to a projection α is picked up by a measurement electronics 7 and forwarded to a computer 8. The measured data now can be suitably processed in the computer 8 and can be visualized first in the form of a sinugram (wherein the projection α is entered as function of the measured values of the corresponding channel β) in units referred to as Gordon units but can be ultimately visualized in Hounsfield units at a monitor 6 in the form of a natural X-ray image.

Due to its very nature (which shall be discussed in detail later), the filter 9 divides the fan beam 13 into two symmetrical halves beyond the center line 12. The filter 9 is rigidly connected to the X-ray tube 1 or to its holding device, so that the physical nature of the ray fan between the X-ray tube 1 and the examination subject 3 does not change during the rotation of X-ray tube 1, filter 9 and detector 2 in the plane 5.

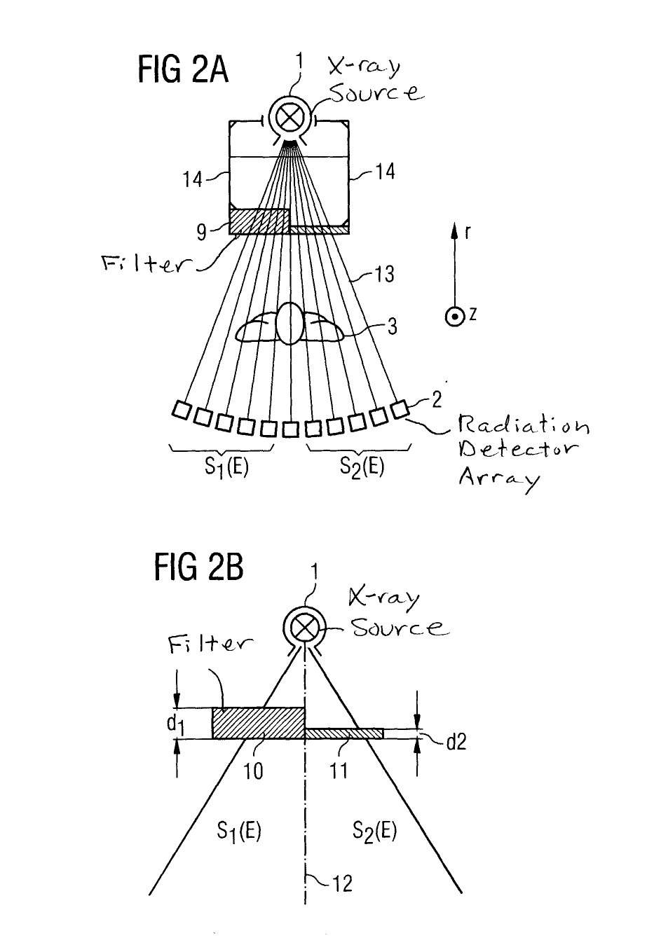

FIG. 2A schematically shows how the two-part filter 9, which is rigidly connected to the X-ray tube 1 with a holding device 14, divides the ray fan 13 generated by the X-ray tube 1 into two ray fans with different intensities S₁ (E) and S₂ (E). The density of the connecting lines between the X-ray tube 1 and the detector 2 should reflect the intensity of the ray fans.

FIG. 2B shows an enlarged view of the filter 9, whose different halves 10 and 11 have different thicknesses d₁ and d₂. The thicknesses typically lie in the range from 0.1 through 1 mm. The two halves 10 and 11 can be composed of different material, with the same or different thicknesses. Metals such as aluminum, copper, titanium, tungsten, etc., are suitable as filter material. Further versions are layer structures of more than one material, for example 0.2 mm Ti+0.8 mm Cu for the first filter 10 and 0.4 mm Al+0.2 mm W for the second filter 11. The X-ray spectra S₁ (E) and S₂ (E) thus can be adapted to the requirements of the respective examination within broad limits and can be designed in view of the highest possible selectivity.

The introduction of the filter preceding the patient has the advantage that the patient is subjected to a lower X-ray dose overall than in the case of known, detector-side modifications for energy-resolving measurements. Additionally, the inventive two-spectra filter is easy to integrate into a conventional CT system since switchable filters (for example, 0.6 and 1.2 mm titanium) are already used now for examining specific body regions of the patient.

Equivalent to the two-spectra method with pulsed tubes, the examination subject (for example, the patient) is completely scanned in the spiral mode of the CT system by employing such a two-spectra filter. A pre-condition for an equivalent resolution in the z-direction (longitudinal axis of the patient) given the same detector φ-resolution (radial resolution), however, is a retarded table feed (pitch) that must be correspondingly set.

Although modifications and changes may be suggested by those skilled in the art, it is the intention of the inventors to embody within the patent warranted hereon all changes and modifications as reasonably and properly come within the scope of their contribution to the art.

We claim as our invention:

1. An X-ray apparatus comprising:
an X-ray source which emits an X-ray beam adapted to transirradiate a subject;
a filter having at least two filter parts disposed in a path of said X-ray beam preceding said subject, said filter dividing said X-ray beam into at least two X-ray beams differing in intensity;
an X-ray detector disposed for detecting X-rays in said X-ray beams after attenuation by said subject and for converting detected X-rays into electrical signals; and
a signal processing device supplied with said electrical signals for determining a distribution of density and atomic number in said subject from said signals.

2. An X-ray apparatus as claimed in claim 1 wherein said X-ray source emits a fan-shaped X-ray beam.

3. An X-ray apparatus as claimed in claim 2 wherein said filter is disposed to divide said fan-shaped beam into two halves.

4. An X-ray apparatus as claimed in claim 3 wherein said filter is disposed to divide said fan-shaped beam into two symmetrical halves, respectively differing in intensity.

5. An X-ray apparatus as claimed in claim 1 wherein said filter parts are respectively composed of different materials.

6. An X-ray apparatus as claimed in claim 1 wherein said filter parts are composed of the same material and have respectively different thicknesses.

7. An X-ray apparatus as claimed in claim 1 wherein said filter parts are respectively composed of different materials and have respectively different thicknesses.

8. An X-ray apparatus as claimed in claim 1 wherein said filter parts are each composed of at least one metal selected from the group consisting of aluminum, copper, titanium and tungsten.

9. An X-ray apparatus as claimed in claim 1 wherein said filter comprises first and second filter parts, and wherein said first filter part produces a first X-ray beam and wherein said radiation detector registers a first distribution of X-ray absorption of said subject resulting from exposure of said subject to said first X-ray beam, and wherein said second part produces a second X-ray beam and wherein said radiation detector registers a second distribution of an X-ray absorption of said subject resulting from exposure of said subject to said second X-ray beam.
